(19) United States
(12) Patent Application Publication
(10) Pub. No.: US 2025/0324011 A1
(43) Pub. Date: Oct. 16, 2025

(54) IMAGE FORMING APPARATUS OPERATING IN ACCORDANCE WITH CONTRACT INFORMATION ACQUIRED FROM SERVER, METHOD FOR CONTROLLING IMAGE FORMING APPARATUS, AND STORAGE MEDIUM

(71) Applicant: CANON KABUSHIKI KAISHA, Tokyo (JP)

(72) Inventor: YOSHIHIRO TSUKADA, Ibaraki (JP)

(21) Appl. No.: 19/174,219

(22) Filed: Apr. 9, 2025

(30) Foreign Application Priority Data
Apr. 12, 2024 (JP) 2024-064558

(51) Int. Cl. H04N 1/44; B41J 3/46; B41J 29/393; H04N 1/00

(52) U.S. Cl. CPC H04N 1/4426; B41J 3/46; B41J 29/393; H04N 1/00244; H04N 1/00411; H04N 1/4433; H04N 2201/0094

(57) ABSTRACT

Provided is an image forming apparatus that allows a user to change contract information which is related to the use of functions of an image forming apparatus and is managed by a server. An image forming apparatus to be communicably connected with the server, includes a memory storing instructions, and at least one processor. The at least one processor executes the instructions to acquire contract information managed by the server, restrict the use of the functions of the image forming apparatus on the basis of the contract information managed by the server, and receive a change in the contract information managed by the server.

### BACKGROUND

### Field of the Disclosure

The present disclosure relates to image forming apparatuses, methods for controlling image forming apparatuses, and storage media.

### Description of the Related Art

For image forming apparatuses having network functions, various services are offered that are implemented by transmitting device information and a user's usage history from an image forming apparatus to a server. Examples of such services include a service for managing consumables such as ink by the server and automatically delivering a consumable product to a user of the image forming apparatus when a remaining amount of the consumable product becomes small, in addition to failure analysis and a billing system.

In recent years, the introduction of a subscription contract has also led to the spread of services for renting a device body and consumables to a user who has made a service contract and performing provision at a flat rate without causing initial investment or maintenance cost. In a contract-type flat-rate service, an image forming apparatus acquires contract information indicating a status of a contract or the like from a server by communicating with the server, and the operation of the image forming apparatus is controlled in accordance with the acquired contract information. Examples of the control of the image forming apparatus in this case include control for limiting or disabling use of functions and settings (including settings in the functions) of the image forming apparatus on the basis of the contract information. It should be noted that functions and settings of an image forming apparatus are abbreviated as “functions of an image forming apparatus” in the present disclosure.

In a system in which an image forming apparatus cooperates with a server to provide the contract-type flat-rate service as in this manner, it is important for the image forming apparatus to acquire the contract information more promptly. In view of this, Japanese Laid-Open Patent Publication (kokai) No. 2018-92548 proposes a technique of transmitting contract information to an image forming apparatus by a push notification from a server using a communication protocol such as message queueing telemetry transport.

Meanwhile, during use of an image forming apparatus, a user may desire to use a function, of which use is restricted on the basis of the contract information, beyond an upper limit when the function is used up to the upper limit, or may desire to use a function of which use is disabled on the basis of the contract information in some cases. In these cases, the user is requested to change the contract information managed by the server via a device other than the image forming apparatus (for example, a personal computer, a smartphone, or the like). This interrupts the user's operation on the image forming apparatus.

### SUMMARY

Embodiments of the present disclosure provide a mechanism in which a user is allowed to change contract information that is related to use of functions of an image forming apparatus and is managed by a server.

According to an aspect of the disclosure, an image forming apparatus, which is to be communicably connected with a server, includes a memory storing instructions and at least one processor. The at least one processor executes the instructions to acquire contract information managed by the server, restrict use of functions of the image forming apparatus on the basis of the contract information managed by the server, and receive a change in the contract information managed by the server.

According to another aspect of the disclosure, a method for controlling an image forming apparatus includes acquiring contract information managed by a server, restricting use of functions of the image forming apparatus on the basis of the contract information managed by the server, and receiving a change in the contract information managed by the server.

According to the present disclosure, a user is allowed to change the contract information which is related to the use of the functions of the image forming apparatus and is managed by the server.

Further features of various embodiments will become apparent from the following description of exemplary embodiments with reference to the attached drawings.

### BRIEF DESCRIPTION OF THE DRAWINGS

FIG. 1 is a diagram illustrating an example of an overall configuration of an information processing system.

FIG. 2 is a diagram illustrating an example of a hardware configuration of a multi-function peripheral (hereinafter, referred to as “MFP”).

FIG. 3 is a diagram illustrating an example of a schematic configuration of hardware of a device management server.

FIG. 4 is a diagram illustrating an example of a schematic configuration of hardware of a service management server.

FIG. 5 is a sequence diagram illustrating an example of processes from contracting for a service until functions of the MFP become available.

FIGS. 6A to 6D are diagrams illustrating examples of a counter created and stored in the MFP.

FIG. 7 is a flowchart illustrating processes from acquisition of contract information to a change of the contract information executed in the MFP.

FIG. 8 is a flowchart illustrating contract information change processing.

FIGS. 9A to 9C are diagrams illustrating examples of a contract change screen displayed on an operation unit of the MFP.

### DESCRIPTION OF THE EMBODIMENTS

Embodiments of the present disclosure will now be described in detail below with reference to the accompanying drawings showing embodiments thereof.

Not all combinations of features described in the following present embodiments are essential to the solutions of the disclosure. In addition, configurations described in the present embodiments are merely examples, and the scopes of some embodiments of the present disclosure are not limited by the configurations described in the present embodiments. For example, each component constituting an embodiment of the present disclosure can be replaced with one having any configuration capable of exhibiting a similar function. In addition, any component may be added to the disclosed configurations. In addition, any two or more configurations (features) of the present embodiments can be combined.

In the present embodiment, an MFP having print functions (including copy functions), scan functions, FAX functions, and the like will be described as an example of an image forming apparatus. However, an image forming apparatus is not limited to an MFP, and may be an apparatus having one or more of the print functions, the copy functions, the scan functions, the FAX functions, and the like.

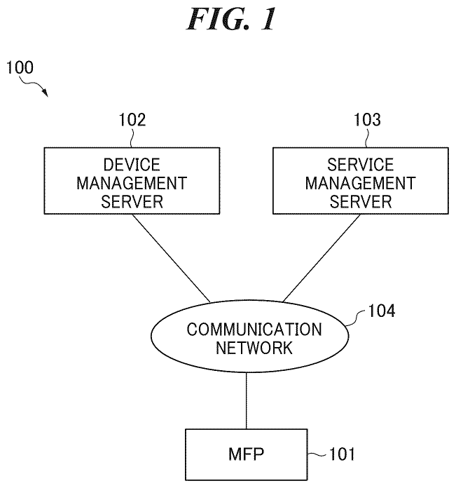

FIG. 1 is a diagram illustrating an example of an overall configuration of an information processing system. An information processing system 100 includes an MFP 101, a device management server 102, and a service management server 103. The MFP 101, the device management server 102, and the service management server 103 are communicably connected with each other via a communication network 104, such as the Internet.

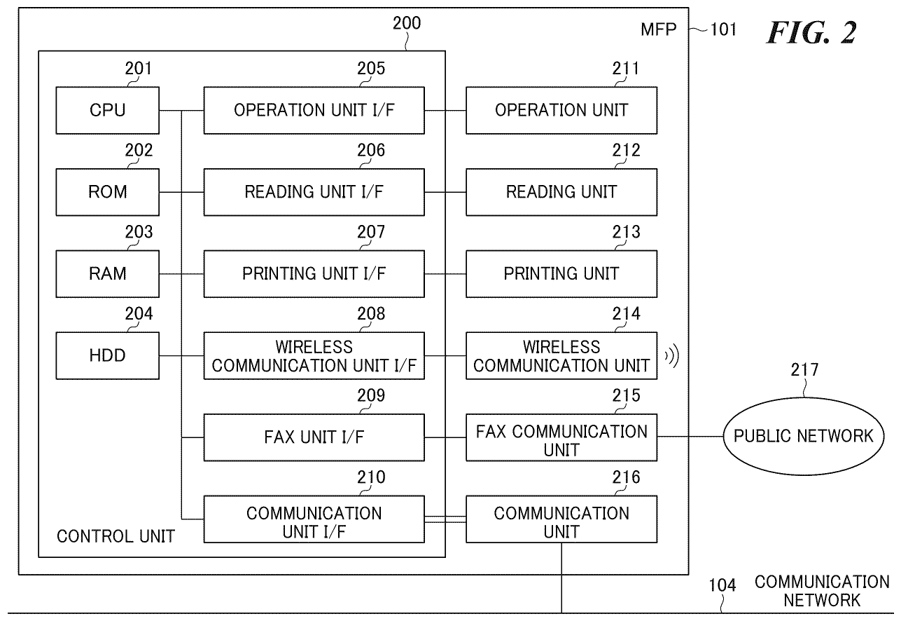

The MFP 101 is configured to store contract information in an HDD (204 in FIG. 2), which will be described later, so that the operation of the MFP 101 is controlled in accordance with the stored contract information. The MFP 101 is configured to acquire the contract information by communicating with the device management server 102 via the communication network 104.

The device management server 102 is configured to store contract information notified from the service management server 103, and provide contract information to the MFP 101 on the basis of the stored contract information. A communication protocol, such as a hypertext transfer protocol (hereinafter, referred to as “HTTP”), is used for the communication between the device management server 102 and the MFP 101, and a known method is used as a control method therefor. In addition, the communication between the device management server 102 and the service management server 103 also uses a communication protocol, such as HTTP.

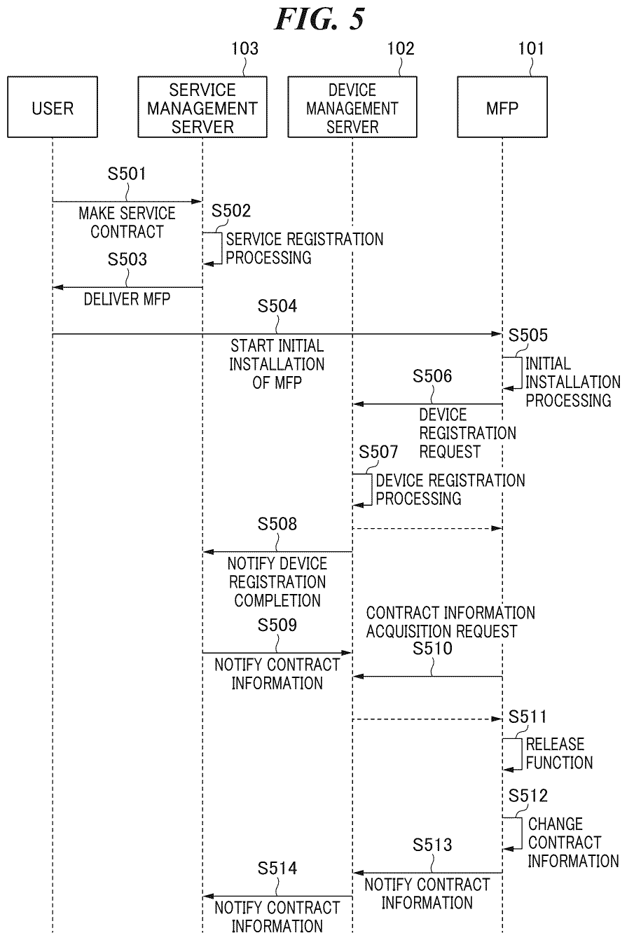

Although the information processing system of the present embodiment is configured such that the communication between the MFP 101 and the service management server 103 is performed via the device management server 102 as illustrated in FIG. 5, which will be described later, the communication is not limited thereto. For example, the MFP 101 and the service management server 103 may directly send and receive contract information and other information via the communication network 104, such as the Internet. In this case, a communication protocol, such as HTTP, may be also used for the communication between the MFP 101 and the service management server 103.

FIG. 2 is a diagram illustrating an example of a hardware configuration of the MFP 101. The MFP 101 includes a control unit 200. The control unit 200 includes a CPU 201, a ROM 202, a RAM 203, an HDD 204, an operation unit interface (I/F) 205, a reading unit interface (I/F) 206, a printing unit interface (I/F) 207, a wireless communication unit interface (I/F) 208, a FAX unit interface (I/F) 209, and a communication unit interface (I/F) 210. In addition, the MFP 101 includes an operation unit 211, a reading unit 212, a printing unit 213, a wireless communication unit 214, a FAX communication unit 215, and a communication unit 216.

The control unit 200 is configured to control the entire operation of the MFP 101 by the CPU 201. The CPU 201 is a computer that performs various types of control such as reading control and printing control, by reading a control program stored in the ROM 202 or the HDD 204 into the RAM 203 and executing the control program.

The ROM 202 stores control programs. Further, the ROM 202 also stores a boot program and font data. The RAM 203 is a main storage memory of the CPU 201 and is used as a work area. The RAM 203 is used as a temporary storage area in which various control programs stored in the ROM 202 or the HDD 204 are loaded.

The HDD 204 stores image data, print data, various programs, various addresses, and various types of setting data. The HDD 204 is a storage medium. It should be noted that, for example, an SSD, an eMMC, or the like may be used, instead of the HDD 204.

It is assumed that one CPU 201 executes processes, which will be described later, using one memory (RAM 203) in the MFP 101, but the execution of the processes in the MFP 101 is not limited thereto. For example, the processes may be executed by a plurality of CPUs, RAMs, ROMs, and HDDs in cooperation. In addition, some processes may be executed by a hardware circuit such as an ASIC or an FPGA.

The operation unit I/F 205 connects the control unit 200 to the operation unit 211. The operation unit 211 is, for example, a user interface including a display, such as a touch panel, and an input apparatus, such as a hard key, and is configured to display information to a user and detect an input from a user. The reading unit I/F 206 connects the control unit 200 to the reading unit 212. The reading unit 212 is, for example, a scanner and is configured to read an image of a document. The image read by the reading unit 212 is converted into image data, such as binary data, by the CPU 201. The image data generated in this manner is transmitted to an external apparatus or printed on a recording sheet.

The printing unit I/F 207 connects the control unit 200 to the printing unit 213. The printing unit 213 is, for example, a printer. The CPU 201 transfers image data (print data) stored in the RAM 203 to the printing unit 213 via the printing unit I/F 207. The printing unit 213 prints an image based on the transferred image data on a recording sheet fed from a sheet feeding cassette (which is not illustrated).

The wireless communication unit I/F 208 is an interface for controlling the wireless communication unit 214, and the wireless communication unit I/F 208 connects the control unit 200 to an external wireless device in a wireless manner. The FAX unit I/F 209 is connected to a public network 217 by controlling the FAX communication unit 215. The FAX unit I/F 209 is an interface for controlling the FAX communication unit 215, and the FAX unit I/F 209 can be connected to the public network 217, control a facsimile communication protocol, and the like by controlling a modem or an NCU for facsimile communication.

The communication unit I/F 210 connects the control unit 200 to the communication network 104 via the communication unit 216. The communication unit I/F 210 uses the communication unit 216 to transmit image data and various types of information inside the MFP 101 to an external apparatus on the communication network 104 and to receive print data and information on the communication network 104 from an external apparatus on the communication network 104. Examples of a method for transmission and reception via the communication network 104 include transmission and reception using electronic mails (e-mail) and file transmission using other protocols (for example, FTP, SMB, WEBDAV, and the like). Further, the communication unit I/F 210 can also transmit and receive image data, various types of setting data, contract information, and the like using the communication network 104 by access from the device management server 102 or the service management server 103 through HTTP communication.

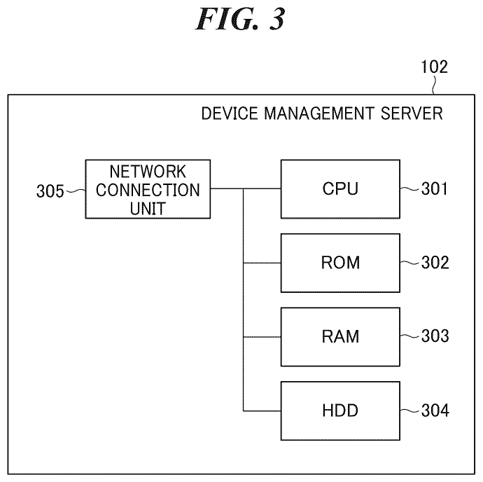

FIG. 3 is a diagram illustrating an example of a schematic hardware configuration of the device management server 102. The device management server 102 includes a CPU 301, a ROM 302, a RAM 303, an HDD 304, and a network connection unit 305.

The CPU 301 is a processor that performs various types of processing, such as calculation, determination, and control of data and commands, according to control programs stored in the ROM 302 or the HDD 304. The ROM 302 stores control programs. The RAM 303 is used as a temporary storage area when the CPU 301 performs various types of processing.

The HDD 304 stores an operating system (OS), application software, and control programs. Device information for each device and contract information indicating a status of service contracts are also stored in the HDD 304. The network connection unit 305 is configured to send and receive data to and from a device on the same network or the Internet using a wireless LAN or a wired LAN conforming to a standard such as IEEE802.11a using a protocol such as TCP/IP.

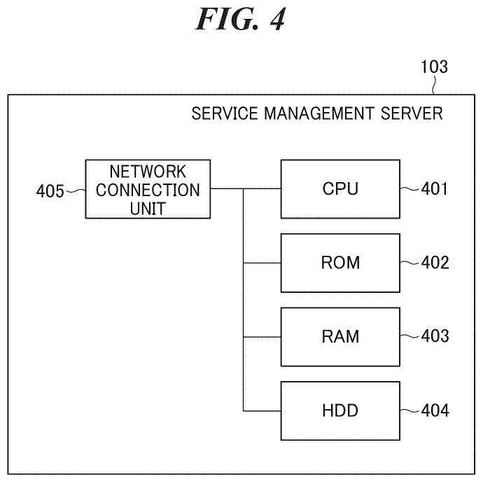

FIG. 4 is a diagram illustrating an example of a schematic configuration of hardware of the service management server 103. The service management server 103 includes a CPU 401, a ROM 402, a RAM 403, an HDD 404, and a network connection unit 405. Since the schematic configuration of hardware of the service management server 103 is similar to that of the device management server 102 described above, a detailed description thereof will be omitted.

It should be noted that the schematic configurations of hardware illustrated in FIGS. 3 and 4 are not limited to the above-described configurations, and for example, a server on a cloud may implement a service that can be provided by the device management server 102 or the service management server 103. In addition, each of the device management server 102 and the service management server 103 does not necessarily include one server. That is, functions provided by the device management server 102 and the service management server 103 may be implemented by a server system including a plurality of (three or more) servers or a single server in which all the functions are aggregated.

FIG. 5 is a sequence diagram illustrating an example of processes from contracting for a service until functions of the MFP 101 become available. The steps of the MFP 101 (method for controlling the image forming apparatus) in FIG. 5 are implemented by the CPU 201 (computer) loading a control program (program) read from the ROM 202 or the HDD 204 into the RAM 203 and executing the control program. The steps of the device management server 102 in FIG. 5 are implemented by the CPU 301 loading a control program read from the ROM 302 or the HDD 304 into the RAM 303 and executing the control program. The steps of the service management server 103 in FIG. 5 are implemented by the CPU 401 loading a control program read from the ROM 402 or the HDD 404 into the RAM 403 and executing the control program.

In step S501, a user accesses a system that manages a service on the service management server 103 via a personal computer, a smartphone, or the like, and makes a service contract on the system. It should be noted that the service contract made by the user is a subscription contract for the MFP 101, and the service contract relates to the use of the functions of the MFP 101.

In step S502, in the service management server 103, the CPU 401 performs service registration processing of associating user information with the MFP 101 in response to the fact that the user has made the service contract. It should be noted that the user information includes contract information regarding the service contract made by the user (hereinafter, also simply referred to as “contract information”). The content of the service registration processing is stored in the HDD 404.

In step S503, when the service registration processing is completed in the service management server 103, a service provider delivers the MFP 101 registered in step S502 to the user. In step S504, when receiving the MFP 101, the user unpacks the MFP 101 and further starts initial installation of the MFP 101.

In step S505, in the MFP 101, the CPU 201 performs initial installation processing in accordance with instructions from the user in the initial installation of the MFP 101. In this initial installation processing, the CPU 201 performs initial settings, such as a network setting for connection to the Internet.

In step S506, in the MFP 101, after network connection is completed in the initial setting, the CPU 201 transmits a device registration request to the device management server 102. In this device registration request communication, the CPU 201 transmits, to the device management server 102, identification information, such as a product serial number of the MFP 101, together with the device registration request.

In step S507, in the device management server 102, the CPU 301 performs device registration processing based on the identification information received from the MFP 101 in response to the device registration request transmitted from the MFP 101. Further, when the device registration processing is completed, the CPU 301 returns a registration result to the MFP 101.

In step S508, in the device management server 102, the CPU 301 makes a device registration completion notification to the service management server 103. At this time, the CPU 301 transmits the identification information, such as the product serial number of the MFP 101, to the service management server 103 together with the device registration completion notification. It should be noted that, in a case where the service management server 103 is made up of a plurality of servers, the device registration completion notification may be made to a server in charge of each corresponding service.

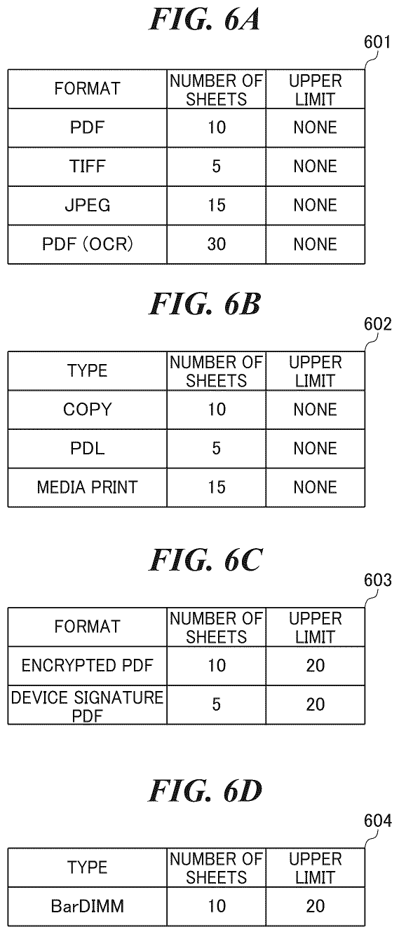

In step S509, in the service management server 103, the CPU 401 makes a contract information notification to the device management server 102 in response to the device management server 102 making the device registration completion notification. In this contract information notification, the CPU 401 notifies the device management server 102 of the contract information associated with the MFP 101. In the present embodiment, the contract information includes information for determining that a contract has been made for use in activation of the MFP 101 after the initial installation, information of upper limit numbers to be used for creating counters in FIGS. 6A to 6D, which will be described later, and the like. It should be noted that the CPU 301 in the device management server 102 stores the contract information notified from the service management server 103 in the HDD 304.

In step S510, in the MFP 101, the CPU 201 transmits a contract information acquisition request to the device management server 102. It should be noted that this contract information acquisition request is a request for collectively acquiring a plurality of pieces of contract information, and this contract information acquisition request is not a request made for each of a plurality of service contracts. Further, in the device management server 102, in response to the contract information acquisition request transmitted from the MFP 101, the CPU 301 notifies the MFP 101 of pieces of the contract information stored in the HDD 304 by an HTTP response.

In step S511, in the MFP 101, when receiving pieces of the contract information from the device management server 102, the CPU 201 stores pieces of the received contract information in the HDD 204. Further, in the MFP 101, the CPU 201 reflects control corresponding to the received contract information to various types of subsequent control such as reading control and printing control.

Specifically, for example, when it has been confirmed that a contract for a service has been made, the CPU 201 releases a function or functions related to the service of which use has been disabled so far so as to be available to the user. The present embodiment is a case where the MFP 101 is provided to the user on condition that the user has made a service contract. Therefore, until it is confirmed in step S511 that the service contract has been made, all the basic functions such as the print functions, the scan functions, and the FAX functions of the MFP 101 are unavailable. After step S511, these functions become available in accordance with the contract information regarding the service contract confirmed to be made.

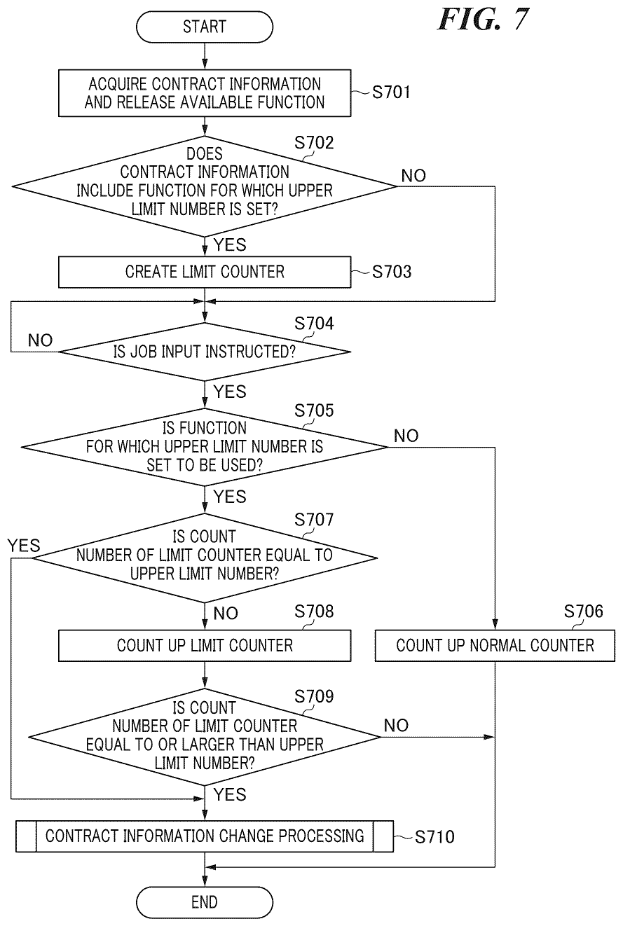

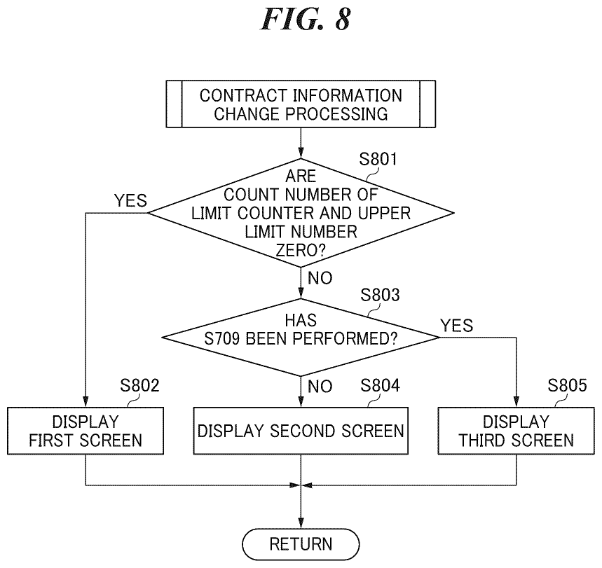

There is a case where the user is allowed to change the contract information on the MFP 101 in the present embodiment. In this case, in step S512, the CPU 201 of the MFP 101 receives a change in the contract information, and changes the contract information stored in the HDD 204. It should be noted that step S512 will be described later in detail with reference to the flowcharts of FIGS. 7 and 8.

In step S513, in the MFP 101, the CPU 201 notifies the device management server 102 of the changed contract information by a HTTP PUT/POST method. As a result, in the device management server 102, the contract information stored in the HDD 304 is updated.

In step S514, in the device management server 102, the CPU 301 notifies the service management server 103 of the contract information notified from the MFP 101 by the HTTP PUT/POST method. As a result, in the service management server 103, the contract information stored in the HDD 404 is updated. It should be noted that the description has been made in the order in which the device registration processing is performed after the service contract is made in the present embodiment, but conversely, the order may be changed such that the service contract is made after the device registration processing is performed.

FIGS. 6A to 6D are diagrams illustrating examples of a counter created by the MFP 101 and stored in the HDD 204. In the MFP 101, the CPU 201 creates counters 601 to 604 on the basis of contract information acquired from the device management server 102. Further, the CPU 201 creates upper limit numbers of the counters 601 to 604, for each file format and for each print type, on the basis of the contract information acquired from the device management server 102.

The counter 601 is a counter for each format for normal scanning that can be used without limitation. In a case of executing a scan job in which the format of a file to be transmitted by e-mail or the like is specified in PDF, TIFF, or the like (as a setting for the scan functions), the number of scanned sheets for the specified format is counted up in the counter 601 as a count number.

The counter 602 is a counter for each print type for normal printing that can be used without limitation. In a case of executing a print job in which the print type is specified in COPY, PDL, or media print (as a setting for the print functions), the number of printed sheets for the specified print type is counted up in the counter 602 as a count number.

The counter 603 is a counter for each format for option scanning, for which an upper limit number is set. In the present embodiment, an encrypted PDF and a device signature PDF are used as examples of the format for the option scanning. In a case of executing a scan job in which the format of a file to be transmitted by e-mail or the like is specified in the encrypted PDF or the device signature PDF, the number of scanned sheets for the specified file format is counted up in the counter 603 as the count number.

The counter 604 is a counter for each print type for optional printing, for which an upper limit number is set. In the present embodiment, BarDIMM are used as an example of the print type for the optional printing. BarDIMM indicates page description language printing that supports a particular barcode font. In a case of executing a print job in which the print type is specified in BarDIMM, the number of printed sheets for the specified print type is counted up in the counter 604 as a count number. It should be noted that each of the counters 601 to 604 is created for each file format or for each print type in the present embodiment, but each counter may be created for, for example, each post-processing, such as stapling.

FIG. 7 is a flowchart illustrating processes from acquisition of contract information to a change of the contract information executed in the MFP 101. The flowchart in FIG. 7 illustrates in detail processes executed in the MFP 101 from step S510 to step S512 in FIG. 5. The steps in FIG. 7 are implemented by the CPU 201 in the MFP 101 loading a control program read from the ROM 202 or the HDD 204 into the RAM 203 and executing the control program. It should be noted that the same applies to the steps in the flowchart of FIG. 8, which will be described later.

In step S701, the CPU 201 acquires contract information from the device management server 102. Further, the CPU 201 releases an available function in accordance with the acquired contract information.

In step S702, the CPU 201 determines whether the contract information includes a function for which an upper limit number is set. When the CPU 201 determines that the contract information includes a function for which the upper limit number is set, the processing proceeds to step S703. On the other hand, when the CPU 201 determines that the contract information does not include any function for which the upper limit number is set, the processing proceeds to step S704.

In step S703, the CPU 201 creates a limit counter (counter) for the function for which the upper limit number is set based on the contract information. Specifically, the counters 603 and 604 in FIGS. 6C and 6D are created as the limit counters. The CPU 201 also creates a limit counter (counter) for a function of which use is disabled based on the contract information. In this case, an upper limit number of the limit counter is set to zero, which is an initial value of the limit counter. These limit counters are used to perform control to restrict (limit or disable) the use of the functions of the MFP 101 on the basis of the contract information. In addition, the counters 601 and 602 in FIGS. 6A and 6B are normal counters, which will be described later, and are created separately from the limit counters.

In step S704, the CPU 201 determines whether job input is instructed by the user. When the CPU 201 determines that job input is not instructed by the user, the processing returns to step S704. On the other hand, when the CPU 201 determines that job input is instructed by the user, the processing proceeds to step S705.

In step S705, the CPU 201 determines whether the input job uses the function for which the upper limit number is set based on the contract information. When the CPU 201 determines that the input job does not use the function for which the upper limit number is set in the contract information, the processing proceeds to step S706. On the other hand, when the CPU 201 determines that the input job uses the function for which the upper limit number is determined in the contract information, the processing proceeds to step S707.

In step S706, the CPU 201 counts up the count number of the normal counter in accordance with the number of scanned sheets or the number of printed sheets when the input job has been executed. Specifically, the count numbers of the counters 601 and 602 in FIGS. 6A and 6B are counted up. Thereafter, the processing of the flowchart of FIG. 7 is completed.

In step S707, the CPU 201 determines whether the count number of the limit counter for the function used by the input job is equal to the upper limit number. When the CPU 201 determines that the count number of the limit counter is not equal to the upper limit number, the processing proceeds to step S708. On the other hand, when the CPU 201 determines that the count number of the limit counter is equal to the upper limit number, the processing proceeds to step S710.

In step S708, the CPU 201 counts up the count number of the limit counter in accordance with the number of scanned sheets or the number of printed sheets when the input job has been executed. Specifically, the count numbers of the counters 603 and 604 in FIGS. 6C and 6D are counted up.

In step S709, the CPU 201 determines whether the count number of the limit counter for the function that has been used by the input job is equal to or larger than the upper limit number. When the CPU 201 determines that the count number of the limit counter is equal to or larger than the upper limit number, the processing proceeds to step S710. On the other hand, when it is determined that the count number of the limit counter is not equal to or larger than the upper limit number, the processing of the flowchart of FIG. 7 ends.

In step S710, the CPU 201 performs contract information change processing. Details of the contract information change processing will be described with reference to the flowchart of FIG. 8.

FIG. 8 is a flowchart illustrating the contract information change processing. In step S801, the CPU 201 determines whether the count number and the upper limit number of the limit counter for the function used by the input job are zero which is an initial value. When the CPU 201 determines that the count number and the upper limit number of the limit counter are zero which is the initial value, the processing proceeds to step S802. On the other hand, when the CPU 201 determines that the count number and the upper limit number of the limit counter are not zero, which is the initial value, the processing proceeds to step S803.

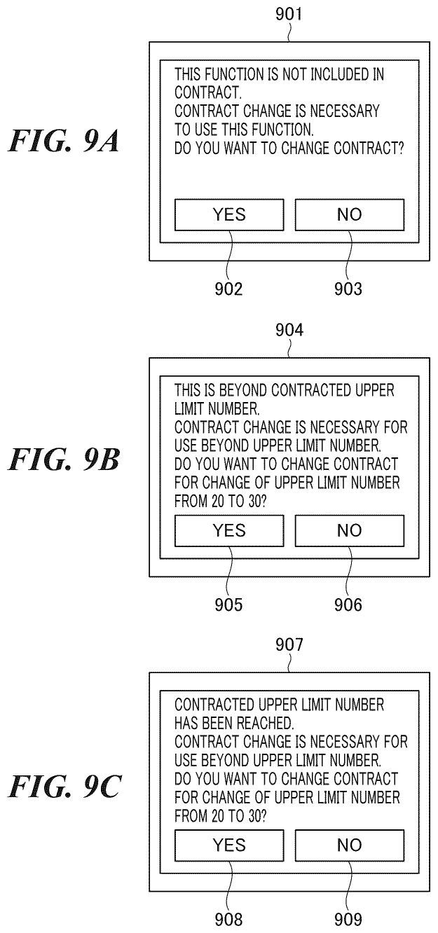

In step S802, the CPU 201 recognizes that an instruction to use the function of which use is disabled based on the contract information has been made (at a predetermined timing), and then displays a first screen (901 in FIG. 9A, a UI screen that receives a change in the contract information), which will described later, on the operation unit 211 without executing the input job. Thereafter, the processing returns to the processing of the flowchart of FIG. 7.

In step S803, the CPU 201 determines whether the process of step S709 has been performed. When the CPU 201 determines that the process of step S709 has not been performed, the processing proceeds to step S804. On the other hand, when the CPU 201 determines that the process of step S709 has been performed, the processing proceeds to step S805.

In step S804, before the execution of the input job, the CPU 201 recognizes that the use of the function of which use is limited on the basis of the contract information has reached an upper limit (at a predetermined timing), and then displays a second screen (904 in FIG. 9B, a UI screen that receives a change in the contract information), which will be described later, on the operation unit 211. Thereafter, the processing returns to the processing of the flowchart of FIG. 7.

In step S805, after the execution of the input job, the CPU 201 recognizes that the use of the function of which use is limited on the basis of the contract information has reached the upper limit or exceeded the upper limit (at a predetermined timing). Further, the CPU 201 displays a third screen (907 in FIG. 9C, a UI screen that receives a change in the contract information), which will be described later, on the operation unit 211. Thereafter, the processing returns to the processing of the flowchart of FIG. 7. After the CPU 201 performs the contract information change processing of step S710, the processing of the flowchart of FIG. 7 ends.

FIGS. 9A to 9C are diagrams illustrating examples of a contract change screen displayed on the operation unit 211 of the MFP 101. The first screen 901 is a contract change screen displayed in a pop-up manner on the operation unit 211 when the count number and the upper limit number of the limit counter for the function to be used by the job are zero before the execution of the input job. That is, the first screen 901 is a pop-up window that is displayed when the use of the function of which use is disabled on the basis of the contract information is instructed. When the user presses a YES button 902 on the first screen 901, the CPU 201 of the MFP 101 changes the contract information in accordance with the content of a message displayed on the first screen 901 in step S512 of FIG. 5. This allows the user to use the function of which use has been disabled on the basis of the contract information before the change. On the other hand, when a NO button 903 is pressed by the user, the CPU 201 of the MFP 101 cancels the input job before the execution without changing the contract information.

The second screen 904 is a contract change screen displayed in a pop-up manner on the operation unit 211 when the count number of the limit counter is not zero and is equal to the upper limit number before the execution of the input job. That is, the second screen 904 is a pop-up window displayed when the use of the function of which use is limited on the basis of the contract information reaches the upper limit before the execution of the input job. When the user presses a YES button 905 on the second screen 904, the CPU 201 of the MFP 101 changes the contract information in accordance with the content of a message displayed on the second screen 904 in step S512 of FIG. 5. This allows the user to, when the use of the function of which use is limited on the basis of the contract information reaches the upper limit, increase the upper limit number of the limit counter for the function. On the other hand, when a NO button 906 is pressed by the user, the CPU 201 of the MFP 101 cancels the input job before the execution without changing the contract information.

The third screen 907 is a contract change screen displayed in a pop-up manner on the operation unit 211 when the count number of the limit counter is not zero and is equal to or larger than the upper limit number after the execution of the input job. That is, the third screen 907 is a pop-up window that is displayed when the use of the function of which use is limited on the basis of the contract information has reached the upper limit or exceeded the upper limit after the execution of the input job. When the user presses a YES button 908 on the third screen 907, the CPU 201 of the MFP 101 changes the contract information in accordance with the content of a message displayed on the third screen 907 in step S512 of FIG. 5. This allows the user to, when the use of the function of which use is limited on the basis of the contract information has reached the upper limit or exceeded the upper limit, increase the upper limit number of the limit counter for the function. On the other hand, when the user presses a NO button 909, the CPU 201 of the MFP 101 does not change the contract information.

As described above, in the present embodiment, a user is allowed to change the contract information that is related to the use of the functions of the MFP 101 and is managed by the service management server 103, during the operation to use the functions of in the MFP 101. That is, the user is allowed to change the contract information via the operation unit 211 of the MFP 101 at a timing when the user wants to use a function of which use is disabled on the basis of the contract information or at a timing when the user wants to use a function of which use is limited on the basis of the contract information beyond an upper limit thereof.

Although an example embodiment of the present disclosure has been described above, some embodiments are not limited to the example embodiment, and various modifications and changes can be made within the scope of the gist of the present disclosure. For example, in step S707, the CPU 201 of the MFP 101 determines whether the count number of the limit counter for the function used by the job is equal to the upper limit number before the execution of the input job. In this regard, the CPU 201 of the MFP 101 may determine whether the count number of the limit counter for the function used by the job is to be equal to or larger than the upper limit number if the input job is executed. In this case, when the CPU 201 of the MFP 101 determines that the count number of the limit counter for the function used by the job is to be equal to or larger than the upper limit number (at a predetermined timing), the second screen 904 is displayed in a pop-up manner on the operation unit 211 of the MFP 101.

Moreover, in step S709, the CPU 201 of the MFP 101 determines whether the count number of the limit counter for the function that has been used by the job is equal to or larger than the upper limit number after the execution of the input job. In this regard, the CPU 201 of the MFP 101 may determine whether the count number of the limit counter for the function being used by the job has reached the upper limit number during the execution of the input job. In this case, when the CPU 201 of the MFP 101 determines that the count number of the limit counter for the function being used by the job has reached the upper limit number (at a predetermined timing), the third screen 907 is displayed in a pop-up manner on the operation unit 211 of the MFP 101. Under this situation, when the user presses the YES button 908 on the third screen 907, the CPU 201 of the MFP 101 changes the contract information such that the job that is being executed can be continued. On the other hand, when the user presses the NO button 909, the CPU 201 of the MFP 101 cancels the job that is being executed without changing the contract information.

Furthermore, the CPU 201 of the MFP 101 may display a button for using the function of which use is disabled on the basis of the contract information in a grayed-out manner or the like on the operation unit 211 of the MFP 101. The button displayed in this manner makes it possible for the user to visually confirm that the function that should be available by pressing the button cannot be used. In this case, when the button is pressed by the user (at a predetermined timing), the CPU 201 of the MFP 101 displays, for example, the first screen 901 in a pop-up manner on the operation unit 211 of the MFP 101.

Furthermore, the CPU 201 of the MFP 101 may display a button for using a function used up to an upper limit among functions of which use is limited on the basis of the contract information in a grayed-out manner or the like on the operation unit 211 of the MFP 101. The button displayed in this manner makes it possible for the user to visually confirm that the function that should be available by pressing the button cannot be used. In this case, when the button is pressed by the user (at a predetermined timing), the CPU 201 of the MFP 101 displays, for example, the third screen 907 in a pop-up manner on the operation unit 211 of the MFP 101.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-064558, which was filed on Apr. 12, 2024 and which is hereby incorporated by reference herein in its entirety.

What is claimed is:

1. An image forming apparatus to be communicably connected with a server, the image forming apparatus comprising:
a memory storing instructions; and
at least one processor that executes the instructions to:
acquire contract information managed by the server;
restrict use of functions of the image forming apparatus on a basis of the contract information managed by the server; and
receive a change in the contract information managed by the server.

2. The image forming apparatus according to claim 1, further comprising a display,
wherein the at least one processor executes the instructions to cause the display to display a screen that receives the change in the contract information managed by the server, in a case where it is determined that use of a function of the image forming apparatus, of which use is restricted on the basis of the contract information managed by the server, reaches an upper limit or exceeds the upper limit.

3. The image forming apparatus according to claim 1, further comprising a display,
wherein the at least one processor executes the instructions to cause the display to display a screen that receives the change in the contract information managed by the server, in a case where it is determined that use of a function of the image forming apparatus, of which use is restricted on the basis of the contract information managed by the server, is instructed.

4. The image forming apparatus according to claim 3, wherein the screen is a pop-up window.

5. The image forming apparatus according to claim 1, further comprising a display,
wherein the at least one processor executes the instructions to:
create a counter having an upper limit number based on the contract information managed by the server for each of the functions of which use is restricted on the basis of the contract information managed by the server;
count up, in response to use of one of the functions of which use is restricted on the basis of the contract information managed by the server in a job, a count number of the counter for the one of the functions used in the job; and
cause the display to display a screen that receives the change in the contract information managed by the server on a basis of the count number and the upper limit number of the counter for the one of the functions.

6. The image forming apparatus according to claim 5,
wherein the at least one processor executes the instructions to cause the display to display the screen that receives the change in the contract information managed by the server, in a case where it is determined, before execution of the job, that the count number of the counter is equal to the upper limit number of the counter.

7. The image forming apparatus according to claim 5,
wherein the at least one processor executes the instructions to cause the display to display the screen that receives the change in the contract information managed by the server, in a case where it is determined, before execution of the job, that the count number of the counter is to be equal to or larger than the upper limit number of the counter when the job is executed.

8. The image forming apparatus according to claim 5,
wherein the at least one processor executes the instructions to cause the display to display the screen that receives the change in the contract information managed by the server, in a case where it is determined, during execution of the job, that the count number of the counter has reached the upper limit number of the counter.

9. The image forming apparatus according to claim 5,
wherein the at least one processor executes the instructions to cause the display to display the screen that receives the change in the contract information managed by the server, in a case where it is determined, after execution of the job, that the count number of the counter is equal to or larger than the upper limit number of the counter.

10. The image forming apparatus according to claim 5,
wherein an initial value of the counter for each of the functions of which use is restricted on the basis of the contract information managed by the server is the upper limit number of the counter for the each of the functions, and
the at least one processor executes the instructions to cause the display to display the screen that receives the change in the contract information managed by the server, in a case where it is determined, before execution of the job, that the count number and the upper limit number of the counter for one of the functions to be used in the job are set to the initial value of the counter.

11. The image forming apparatus according to claim 1, further comprising a display,
wherein the at least one processor executes the instructions to cause the display to display a screen that receives the change in the contract information managed by the server, in a case where it is determined that a button for using a function of the image forming apparatus, of which use is restricted on the basis of the contract information managed by the server, is pressed.

12. The image forming apparatus according to claim 11,
wherein the at least one processor executes the instructions to cause the display to display the button in a grayed-out manner.

13. The image forming apparatus according to claim 1, further comprising a display,
wherein the at least one processor executes the instructions to cause the display to display a screen that receives the change in the contract information managed by the server, in a case where it is determined that a button for using a function used up to an upper limit among the functions of which use is restricted on the basis of the contract information managed by the server is pressed.

14. The image forming apparatus according to claim 13,
wherein the at least one processor executes the instructions to cause the display to display the button in a grayed-out manner.

15. The image forming apparatus according to claim 1,
wherein, when the use of the functions of the image forming apparatus is restricted on the basis of the contract information managed by the server, the use of the functions of the image forming apparatus is limited up to respective upper limits on the basis of the contract information managed by the server.

16. A method for controlling an image forming apparatus, the method comprising:
acquiring contract information managed by a server;
restricting use of functions of the image forming apparatus on a basis of the contract information managed by the server; and
receiving a change in the contract information managed by the server.

17. A non-transitory computer-readable storage medium storing instructions for causing an image forming apparatus to perform a process comprising:
acquiring contract information managed by a server;
restricting use of functions of the image forming apparatus on a basis of the contract information managed by the server; and
receiving a change in the contract information managed by the server.
